(19) United States
(12) Patent Application Publication
(10) Pub. No.: US 2006/0253698 A1
(43) Pub. Date: Nov. 9, 2006

(54) Method, system and entities for exchanging content

(76) Inventors: Sujeet Mate, Tampere (FI); Kai Willner, Tampere (FI); Umesh Chandra, Allen, TX (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/170,136

(22) Filed: Jun. 30, 2005

Related U.S. Application Data
(60) Provisional application No. 60/677,322, filed on May 4, 2005.

(51) Int. Cl. H04L 9/00; H04L 9/32; G06F 15/16; G06F 17/30; G06F 7/04; G06F 7/58; G06K 19/00; G06K 9/00

(52) U.S. Cl. 713/151; 726/3

(57) ABSTRACT

A method for exchanging content between a server entity (UA-I) and a client entity (UA-II). The method includes establishing a session between the server entity and the client entity based on a session control layer protocol, initiating a content exchange session between the server entity and the client entity based on an application layer session protocol. Furthermore, the method includes transmitting intra-session control data based on a transport mechanism of the session control layer protocol, wherein the intra-session control data controls the content exchange session.

This application claims benefit under 35 U.S.C. §119(e) of provisional application No. 60/677,322, filed on May 4, 2005 the contents of which is incorporated by reference.

### FIELD OF THE INVENTION

The present invention relates to a method and system for exchanging content between a server entity and a client entity as well as to the corresponding server and client entities for exchanging content.

### BACKGROUND OF THE INVENTION

With the increasing popularity and acceptance of modern communication, a vast variety of applications was and is developed to provide additional services to the end users of communication devices.

Thus, using means of communication does not only allow for making a conventional phone call, but in the meantime also enables users to access the Internet from their wirebound as well as from their mobile terminal, or—with some adaptations and an appropriate application being run on it—to use your mobile terminal for navigation purposes.

Another example for a quite popular application is gaming or sending of images that were taken with a digital camera integrated to the communication device. Even beyond the mere sending of e.g. image data is the sharing of such data with plural other users, which may access the image data at a time they wish to do so.

Such a sharing of content such as images with communication partners is becoming particularly popular. To this end, an image is not only sent to one specific communication partner, but it is made available, for example at a server, to be accessed by a plurality of other users of communication devices.

For the purpose of the present invention to be described herein below, it should be noted that
a communication device may for example be any device by means of which a user may access a communication network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals are particularly suitable for being used in connection with the present invention;
a communication device can act as a client entity or as a server entity in terms of the present invention, or may even have both functionalities integrated therein;
although reference was made herein before to images, this exemplifies only a specific example of content; content as used in the present invention is intended to mean at least one of audio data, video data, image data, text data, and metadata descriptive of attributes of the audio, video, image and/or text data, any combination thereof or even, alternatively or additionally, other data such as, as a further example, program code of an application program to be accessed/downloaded;
method steps likely to be implemented as software code portions and being run using a processor at one of the server/client entities are software code independent and can be specified using any known or future developed programming language as long as the functionality defined by the method steps is preserved;
method steps and/or devices likely to be implemented as hardware components at one of the server/client entities are hardware independent and can be implemented using any known or future developed hardware technology or any hybrids of these, such as MOS, CMOS, BiCMOS, ECL, TTL, etc., using for example ASIC components or DSP components, as an example;
generally, any method step is suitable to be implemented as software or by hardware without changing the idea of the present invention in terms of the functionality implemented;
devices can be implemented as individual devices, but this does not exclude that they are implemented in a distributed fashion throughout the system, as long as the functionality of the device is preserved.

In the patent application filed in the name of Nokia Corporation on Dec. 23, 2003 under the serial number PCT/IB 03/06134, a method, system and terminals for exchanging images and image related data between at least two end points are described.

Insofar, this document describes a method for exchanging images as a type of content between a server entity and a client entity as respective end points. The method comprises the steps of establishing a session between the server entity and the client entity based on a session control layer protocol, and initiating a content exchange session between the server entity and the client entity based on an application layer session protocol.

FIG. 1 exemplifies this interrelation for the situation as an example for explaining the present invention as well as the arrangement in the referenced document. In the illustrated example, the session control layer protocol is the Session Initiation Protocol, SIP, and the session established is a SIP session operated on a SIP/SDP protocol stack and is thus located on layers 5 to 7 of the OSI reference model (SDP=Session Description Protocol, OSI=Open System Interconnection). The application layer (OSI layer 7) session protocol, in turn, is the JPEG 2000 Interactive Protocol, JPIP, and the content exchange session established is a JPIP session. FIG. 1 refers to the SIP session layer as the control layer for the exchange of content, whereas the JPIP session layer is referred to as the data layer in which the content (application data) are carried.

Note that SIP and JPIP are used only as an example as they have proved to be particularly suited for (interactive and real-time) content exchange so far. However, making reference to these particular standards does not limit the principles of the present invention as described later to be applied to other protocols, whether existing ones or future developed ones.

JPEG 2000 is the state-of-the-art image compression standard being developed under the aegis of ISO/IEC and ITU-T. Part 9 of the standard, JPEG 2000 Interactive Protocol (JPIP), is in its Final Draft stage and was intended to be finalized before the end of 2004. JPIP is a protocol that allows for the interactive and progressive transmission of JPEG 2000 coded data in a client-server scenario over a network. The JPIP protocol consists of a structured series of interactions between a client and a server by means of which image file metadata, structure and partial or whole image codestreams may be exchanged in a communication efficient manner. The JPIP standard also defines the semantics and the values to be exchanged, and suggests how these parameters could be signaled over different network transports. The JPIP protocol can enable an interactive image browsing, image and metadata retrieval, and image uploading system.

Metadata are data descriptive of attributes of the content such as e.g. audio, video, image and/or text data, or the like. This implies a size information, date information of the content (e.g. creation date, modification date), or any other attributes for files containing content data.

The Session Initiation Protocol (SIP) (specified e.g. in RFC 2543, RFC 3261), is an application-layer signaling (control) protocol defined by IETF. It is used for creating, modifying and terminating sessions with one or more participants. These sessions could be IP based videoconferences, VOIP (Voice over IP), shared whiteboard, multimedia distribution, messaging sessions, etc. SIP/SDP provides for parameter negotiation before initiating the session. Actually it is SDP, which provides the negotiation of the parameters. The SIP INVITE message body carries the SDP parameters. 3GPP standard has also decided to go with SIP.

SIP also has a feature to provide for transmission of mid-session control data using the SIP INFO method (specified in RFC 2976). The purpose of SIP INFO messages is to carry application level information along the SIP signaling path (or they can be sent end-to-end). The SIP INFO method is not used to change the state of SIP calls/SIP sessions, or the parameters of the sessions SIP/SDP initiates. Rather, it merely sends optional application layer information, generally related to the session. In particular, RFC 2976 specifies that SIP INFO messages having bodies which would imply a change in the SIP call state or the sessions initiated by SIP MUST NOT be sent in an INFO message.

Thus, the SIP INFO method is not used to change the state of SIP calls, or the parameters of the sessions SIP initiates. It merely sends optional application layer information, generally related to the session.

SIP/SDP is thus used to initiate a session between two JPIP-enabled terminals. This allows for parameter negotiation before the session is established. SIP defines session control messages used during the setup and teardown stages of SIP controlled sessions. In addition, SIP re-INVITE is employed in case of a change in characteristics of the session. But this is used generally in case of a change in properties of a media flow or content flow. Like for example in case the JPIP session needs to be started on another port.

With such prior art concepts, however, there are still some problems or inconveniences to be overcome:

To exchange data, like for example, metadata descriptive of new target information (new content such as images or the like that were captured, made available for browsing, etc), is not enabled in existing scenarios without modifying the session or tearing down an existing and initiating a new one. Rather, signaling this information is out of scope for JPIP. This data either needs to be exchanged through the signaling path (SIP messages), or, as they do not have to go through the signaling path, they can be exchanged end-to-end. However, a mechanism to transfer mid-session control data for SIP based image browsing is not present.

There is not only the lack of mechanisms for transferring such control data, but also transmission of mid-session control data for SIP sessions is not even standardized as there is no adapted standard to exchange mid-session control data. There have been a few implementations like transmission of ISUP data (Integrated Service Digital Network User Part).

In summary, there is no standard for SIP based interactive image browsing sessions present, and with the syntax and semantics for usage being undefined, it needs to be defined for usage in SIP based interactive image browsing sessions.

### SUMMARY OF THE INVENTION

In consideration of the above, it is an object of the present invention to provide a method and system for exchanging content between a server entity and a client entity, as well as correspondingly configured client and server entities which are free from the above inconveniences.

According to the present invention, this object is achieved by a method for exchanging content between a server entity and a client entity, the method comprising the steps of: establishing a session between the server entity and the client entity based on a session control layer protocol, initiating a content exchange session between the server entity and the client entity based on an application layer session protocol, and transmitting intra-session control data based on an intra-session transport mechanism of the session control layer protocol, wherein said intra-session control data controls the content exchange session.

According to advantageous further refinements of the invention as defined under the above aspect
content consists of at least one of audio data, video data, image data, text data, and metadata descriptive of attributes of the audio, video, image and/or text data;
the session control layer protocol is the Session Initiation Protocol, SIP, and the session established is a SIP session;
the application layer session protocol is the JPEG 2000 Interactive Protocol, JPIP, and the content exchange session established is a JPIP session;
the session control layer protocol is the Session Initiation Protocol, SIP, and the session established is a SIP session, the intra-session transport mechanism is based on the SIP INFO message;
the transmitting step further comprises a step of requesting, by the client entity, for an indication of content accessible for the content exchange session;
the requesting step further comprises a step of pre-selecting at least one content access criterion for the content to be accessed in the content exchange session;
the transmitting step further comprises a step of responding, by the server entity, to the request for an indication, wherein the responding step further comprises a step of indicating content accessible if the request was judged by the server entity to be granted;
said responding step comprises a step of judging, prior to indicating, whether the request received matches at least one content access criterion for requests of the client entity, wherein the request is granted if it is judged that a matching content access criterion is present;
the step of judging is based on at least a client entity's profile;
the step of judging is based on at least one further content access criterion for the content to be accessed in the content exchange session and contained in the request step;
the transmitting step further comprises a step of requesting, by the client entity, for delivering a specified content accessible for the content exchange session;
the transmitting step further comprises a step of responding, by the server entity, to the request for delivering, wherein the responding step further comprises a step of delivering the requested content in the content exchange session;
the transmitting step further comprises a step of responding, by the server entity, to the request for delivering, wherein the responding step further comprises a step of delivering the requested content if the request was judged by the server entity to be granted;
said responding step comprises a step of judging, prior to delivering, whether the request received matches at least one content access criterion for requests of the client entity, wherein the request is granted if it is judged that a matching content access criterion is present;
the step of judging is based on at least a client entity's profile;
the step of judging is based on at least one further content access criterion for the content to be delivered in the content exchange session and contained in the request step;
further comprising a step of detecting, at the server entity, the occurrence of additional content;
further comprising a step of indicating, by the server entity to the client entity, an indication of content accessible for the content exchange session, wherein the indication comprises at least an information related to the additional content.

According to the present invention, this object is achieved by a system configured to exchange content between a server entity and a client entity, the system comprising: session establisher devices at the server entity and the client entity, configured to establish a session between the server entity and the client entity based on a session control layer protocol, content exchange session initiator devices, at the server entity and the client entity, configured to initiate a content exchange session between the server entity and the client entity based on an application layer session protocol, and transceiver devices, at the server entity and the client entity, configured to transmit and receive intra-session control data based on an intra-session transport mechanism of the session control layer protocol, wherein said intra-session control data is configured to control the content exchange session.

According to advantageous further refinements of the invention as defined under the above aspect
the system further comprises at least one memory configured to store content, wherein content consists of at least one of audio data, video data, image data, text data, and metadata descriptive of attributes of the audio, video, image, and/or text data;
the session control layer protocol is the Session Initiation Protocol, SIP, and the session established is a SIP session;
the application layer session protocol is the JPEG 2000 Interactive Protocol, JPIP, and the content exchange session established is a JPIP session;
the session control layer protocol is the Session Initiation Protocol, SIP, and the session established is a SIP session, the intra-session transport mechanism is based on the SIP INFO message;
the transceiver device further comprises a requester, at the client entity, configured to request for an indication of content accessible for the content exchange session;
the requester further comprises a pre-selector configured to pre-select at least one content access criterion for the content to be accessed in the content exchange session;
the transceiver further comprises a responder, at the server entity, configured to respond to the request for an indication, wherein the responder is configured to indicate, in the response, content accessible if the request was judged by the server entity to be granted;
said responder comprises a judgment element, configured to judge, prior to a response with an indication, whether the request received matches at least one content access criterion for requests of the client entity, wherein the request is granted if it is judged that a matching content access criterion is present;
the judgment element is configured to make a judgment based on at least a client entity's profile;
the judgment element is configured to make a judgment based on at least one further content access criterion for the content to be accessed in the content exchange session and contained in the request step;
the transceiver further comprises a requester, at the client entity, configured to request for delivering a specified content accessible for the content exchange session;
the transceiver further comprises a responder, at the server entity, configured to respond to the request for delivering, wherein the responder is further configured to deliver the requested content in the content exchange session;
the transmitting further comprises a responder, at the server entity, configured to respond to the request for delivering, wherein the responder is further configured to deliver the requested content if the request was judged by the server entity to be granted;
said responder comprises a judgment element, configured to judge, prior to delivering, whether the request received matches at least one content access criterion for requests of the client entity, wherein the request is granted if it is judged that a matching content access criterion is present;
the judgment is based on at least a client entity's profile;
the judgment is based on at least one further content access criterion for the content to be delivered in the content exchange session and contained in the request step;
the system further comprises a detector, at the server entity, configured to detect the occurrence of additional content;
the transceiver, at the server entity, is configured to indicate, responsive to the detector and from the server entity to the client entity, content accessible for the content exchange session, wherein the indication comprises at least an information related to the additional content.

According to the present invention, this object is achieved by a server entity configured to exchange content with a client entity, the server entity comprising: session establisher devices, configured to establish a session between the server entity and the client entity based on a session control layer protocol, content exchange session initiator devices, configured to initiate a content exchange session between the server entity and the client entity based on an application layer session protocol, and transceiver devices, configured to transmit intra-session control data based on an intra-session transport mechanism of the session control layer protocol, wherein said intra-session control data is configured to control the content exchange session.

According to advantageous further refinements of the invention as defined under the above aspect
the server entity further comprises at least one memory configured to store content, wherein content consists of at least one of audio data, video data, image data, text data, and metadata descriptive of attributes of the audio, video, image, and/or text data;
wherein the session control layer protocol is the Session Initiation Protocol, SIP, and the session established is a SIP session;
wherein the application layer session protocol is the JPEG 2000 Interactive Protocol, JPIP, and the content exchange session established is a JPIP session;
the session control layer protocol is the Session Initiation Protocol, SIP, and the session established is a SIP session, the intra-session transport mechanism is based on the SIP INFO message;
the transceiver further comprises a responder configured to respond to a request for an indication received from a client entity, wherein the responder is configured to indicate, in the response, content accessible if the request was judged to be granted;
said responder comprises a judgment element, configured to judge whether the request received matches at least one content access criterion for requests of the client entity, wherein the request is granted if it is judged that a matching content access criterion is present;
the judgment element is configured to make a judgment based on at least a client entity's profile;
the judgment element is configured to make a judgment based on at least one further content access criterion for the content to be accessed in the content exchange session and contained in the request step;
wherein the transceiver further comprises a responder configured to respond to a request for delivering from a client entity, wherein the responder is further configured to deliver the requested content in the content exchange session;
the transmitting further comprises a responder, configured to respond to the request for delivering, wherein the responder is further configured to deliver the requested content if the request was judged by the server entity to be granted;
said responder comprises a judgment element, configured to judge, prior to delivering, whether the request received matches at least one content access criterion for requests of the client entity, wherein the request is granted if it is judged that a matching content access criterion is present;
the judgment is based on at least a client entity's profile;
the judgment is based on at least one further content access criterion for the content to be delivered in the content exchange session and contained in the request;
the server entity further comprises a detector configured to detect the occurrence of additional content;
the transceiver is configured to indicate, responsive to the detector, to the client entity, content accessible for the content exchange session, wherein the indication comprises at least an information related to the additional content.

According to the present invention, this object is achieved by a client entity configured to exchange content with a server entity, the client entity comprising: session establisher devices configured to establish a session between a server entity and the client entity based on a session control layer protocol, content exchange session initiator devices configured to initiate a content exchange session between the server entity and the client entity based on an application layer session protocol, and transceiver devices configured to transmit intra-session control data based on a transport mechanism of the session control layer protocol, wherein said intra-session control data is configured to control the content exchange session.

According to advantageous further refinements of the invention as defined under the above aspect
content exchanged consists of at least one of audio data, video data, image data, text data, and metadata descriptive of attributes of the audio, video, image, and/or text data;
the session control layer protocol is the Session Initiation Protocol, SIP, and the session established is a SIP session;
the application layer session protocol is the JPEG 2000 Interactive Protocol, JPIP, and the content exchange session established is a JPIP session;
the session control layer protocol is the Session Initiation Protocol, SIP, and the session established is a SIP session, the intra-session transport mechanism is based on the SIP INFO message;
the transceiver device further comprises a requester configured to request, from the server entity, for an indication of content accessible for the content exchange session;
the requester further comprises a pre-selector configured to pre-select at least one content access criterion for the content to be accessed in the content exchange session.
the transceiver further comprises a requester configured to request, from the server entity, for delivering a specified content accessible for the content exchange session.

Various aspects of the method, system, and server and client entities have been identified above. It is to be understood that individual features under one of these aspects can be combined with each other. Namely, the general concept is applicable to accomplish a feature referred to as access control, as well as to target change and real-time update, and these—though individually described—, can be freely combined so that a respective system and/or entity is capable to successfully handle one or more or even each of these aspects. The description is split in these aspects only to keep the explanations simple.

Accordingly, with the present invention being implemented, several advantages can be achieved.

Thus, this invention relates to the beneficial use of SIP INFO method, now adapted for the exchange of control data after a SIP initiated JPIP based interactive image browsing session has already been established in, for example, a Rich Call scenario. A rich call scenario means a scenario in which a so called rich call session is established, i.e. a session in which other media content, such as voice, can be added to image content and enrich the interactive experience. However, rich calls are not restricted to a combination of images and voice data, but any other content types may likewise be combined in a rich call session.

This would provide for transmitting JPIP related information for an enhanced image browsing experience without modifying the SIP session.

In this invention, it is described a method and system with correspondingly configured client and/or server entities for transmitting mid-session control data for an interactive image sharing between involved entities.

As an example to illustrate the principles taught by the present invention, multimedia terminals during SIP initiated JPIP based Rich Call sessions using SIP INFO method as the transport mechanism are referred to. However, this example does not limit the applicability of the present invention to other scenarios and/or protocols.

Thus, SIP INFO as an example of an intra-session transport mechanism enables transfer of mid-session application data, which is typically not required for most of continuous media types like Audio, Video, etc. (Note that “mid-session” as well as “intra-session” may synonymously be used as expressions.) Transmitting mid-session control data is critical for a real-time interactive JPIP based image browsing system. This would not only allow for choosing the available target images from the server but also allow the server to conduct e.g. a content access control policy based on the requesting user. Furthermore, it can provide for file access directly from a file-system or a database along with the associated metadata. It is to be noted that the (content) access-control policy is not the SIP session establishment policy but, related to image-access level of the client, and thus refers to accessing content. I.e. a client could establish a SIP call but not view a particular image or view it with restriction.

The usage of the SIP INFO method as an intra-session transport mechanism brings some information in the middle of the session without changing the session itself. The alternative way of doing it would be to re-negotiate the session, which may be quite heavy and can thus be avoided.

SIP based real-time interactive image sharing is a new concept. Hence, the solution of using SIP INFO method for exchange of mid-session control data during interactive image browsing sessions has not been introduced in SIP based multimedia environment.

This invention enables real-time interactivity in SIP based image sharing sessions. This invention overcomes the problems faced in using SIP for interactive media.

Following are some of the advantages of the invention:
It provides for enhanced interactivity between client and the server to request new and different content such as images (targets). This enables to have multiple image sharing sessions in the same SIP session.
It provides for transmission of real-time application (JPIP session) related information. JPIP server can offer even those images, which became available to the server only after the SIP based image sharing session was established.
It allows interactive image sharing systems to incorporate high-level features like content access control list, meta-data based image listing, etc.

### BRIEF DESCRIPTION OF THE DRAWINGS

The present invention is described herein below with reference to the accompanying drawings, in which

FIG. 1 shows the two-layered structure of a typical JPIP Interactive image browsing system;

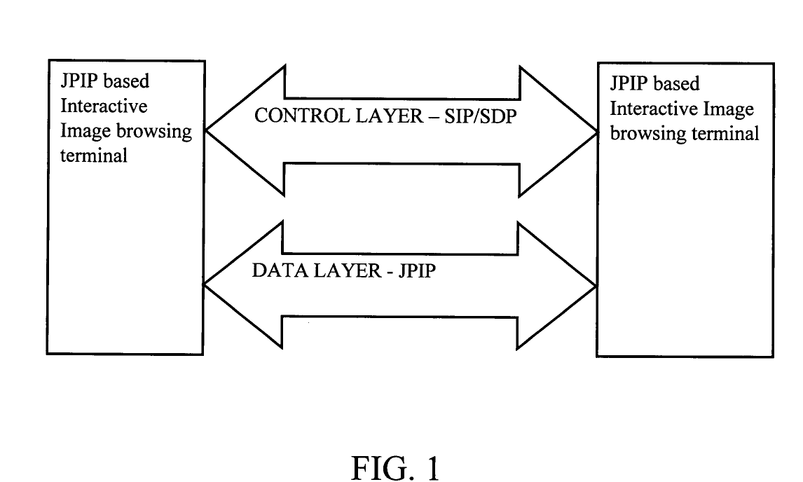

FIG. 2 shows the typical steps involved in the present invention when making use of SIP INFO according to the general concept of the present invention;

FIG. 3 shows an access control case where image listing is offered on the basis of some server specified content access control criteria;

FIG. 4 shows a typical target-change case of a target-change by the client based on information supplied by the server;

FIG. 5 shows the case of real-time update, which is enabled according to an other aspect of the present invention, which would not be possible if the target information is sent only during the startup;

FIG. 6 shows as a block circuit diagram those components of a server entity being related to a server entity aspect the present invention; and

FIG. 7 shows as a block circuit diagram those components of a client entity being related to a client entity aspect the present invention.

### DETAILED DESCRIPTION OF EMBODIMENTS OF THE INVENTION

The present invention is described herein below with reference to the accompanying drawings.

The drawings illustrate aspects and/or individual partial concepts that can be realized by the present invention when being implemented. Concepts and their features can be realized as an individual feature or can be combined with other concepts disclosed herein and their respective features without any restriction. This means that on the basis of the general concept, content access control can be combined with target change and/or real-time update in an arbitrary combination of aspects.

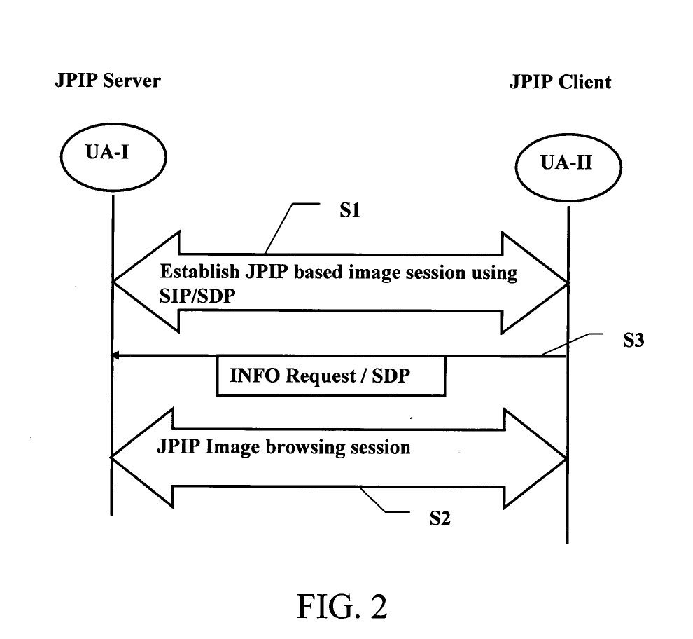

FIG. 2 shows the typical steps involved in the present invention when making use of SIP INFO as an intra-session transport mechanism according to the general concept of the present invention. For the sake of clarity, it is to be noted that throughout the present application, SIP INFO being mentioned as an intra-session transport “mechanism” for control data is to be understood as follows: The SIP INFO is a message of SIP which carries a payload (message body) consisting of the control data relating to JPIP session. Actual (physical) transport of that message is accomplished like other SIP messages, i.e. either along the signaling path of the session control layer protocol (SIP), or, as they do not have to go through that signaling path, they can be exchanged end-to-end.

Thus, in this regard, the invention relates to a method for exchanging content between a server entity UA-I and a client entity UA-II. Basically, the method comprises the steps, S1, of establishing a session between the server entity and the client entity based on a session control layer protocol. In FIG. 2, SIP/SDP protocol stack has been chosen as an example for this, so that the session control layer protocol is the Session Initiation Protocol, SIP, and the session established is a SIP/SDP session. Furthermore, the method involves, S2, initiating a content exchange session between the server entity and the client entity based on an application layer session protocol. In FIG. 2, JPIP has been chosen as an example for this, so that the application layer session protocol is the JPEG 2000 Interactive Protocol, JPIP, and the content exchange session established is a JPIP session.

In addition to pre-existing concepts, according to the present invention, there occurs, S3, a transmitting of intra-session control data based on an intra-session transport mechanism (SIP INFO Message) of the session control layer protocol, wherein said intra-session control data controls the content exchange session. In FIG. 2, SIP INFO has been chosen as an example for this intra-session transport mechanism of the session control layer protocol, which carries the intra-session control data either along the signaling path of the session control layer protocol, or; as they do not have to go through the signaling path, they can be exchanged end-to-end.

In a particular implementation, content consists of at least one of audio data, video data, image data, text data, and metadata descriptive of attributes of the audio, video, image, and/or text data.

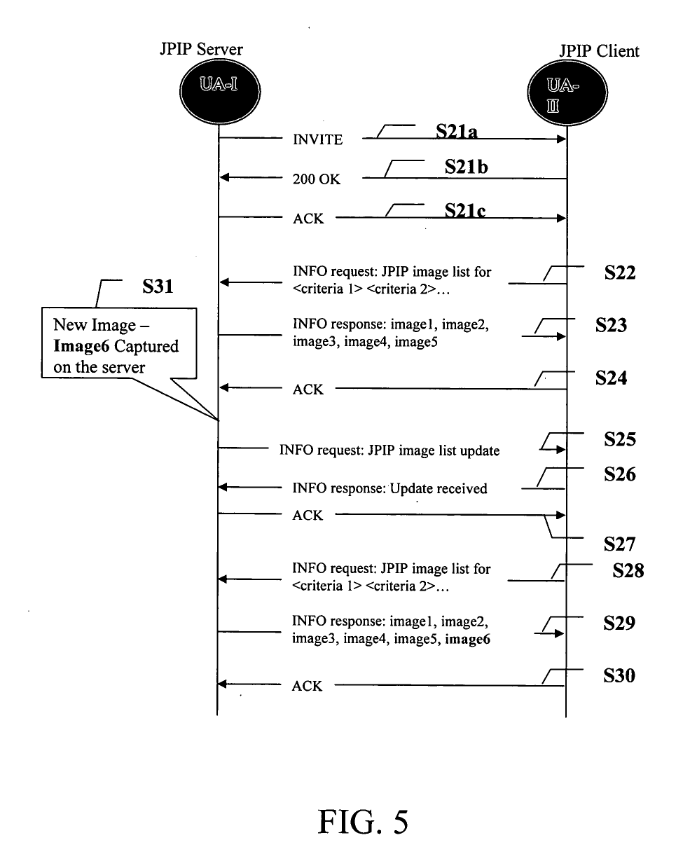

This invention thus deals with utilizing, in one example, the SIP framework to send mid-session JPIP related data without modifying the SIP session. This kind of framework is crucial for an interactive image browsing system, where new images or content in general could be generated “on the fly”, i.e. even during an existing, pre-established session. A client could be asked verbally (e.g. by an end-user) e.g. in case of a Rich Call scenario implementation, to request any new content such as images (from a server). Another possible alternative of updating the client's image-list of images or, generally, content accessible to the client could be to send a SIP INFO message to the client whenever there is an update in the images conforming to the content access control criteria at the start of the session. (This will be described later on with reference to FIG. 5.) The above-mentioned mechanism (usage of SIP INFO message) even allows the JPIP client to get content such as images that were captured after the image browsing session started and thus enables a real-time update feature.

JPIP is a standard that primarily deals with the semantics and signaling mechanism between a client and server to enable browsing of primarily JPEG 2000 images in a communication efficient manner. This involves an assumption that for example, the client has a priori knowledge of the (content) targets available at the server for browsing. The JPIP protocol doesn't deal with communication of any information, apart from the request for specific JPEG 2000 code stream data or response signaling for the data corresponding to this JPEG 2000 code stream.

The architecture of SIP initiated JPIP based interactive image browsing sessions shows two layers:

All non-JPIP data needs to be communicated through the SIP layer (SIP/SDP) (signaling/session establishment, etc).

Content data such as image data is communicated through the JPIP layer (data layer). This consists of JPIP requests and responses. Transmission of any non-JPIP data during an interactive image browsing session involves sending that data via the signaling layer.

In the present invention, the SIP INFO message based method provided in the SIP framework can be utilized as the intra-session transport mechanism for this purpose. Thus, non-JPIP information like target information from server, image-listing based on certain (content access) criteria is requested and received via the SIP layer.

The peculiar advantage of using the SIP INFO message based method lies in its inherent intent. This method is not supposed to carry any data that would change the SIP session state. Only under circumstances where for example the port or any other transport parameter of the JPIP session needs to be changed, there is a need to modify the SIP session. Otherwise, the SIP INFO message based method would simply carry lightweight application related information that is needed in the middle of the SIP session. In the present case, this application related information is the JPIP related information.

Thus, the invention proposes a concept according to which there is a transmitting of intra-session control data based on an intra-session transport mechanism of the session control layer protocol, wherein said intra-session control data controls the content exchange session.

The interactive content browsing system (e.g. using images as an example of content) could be implemented on any high-end multimedia terminal that has e.g. SIP and JPIP enabled when referring to the chosen example implementation. The choice of device could range from a Personal Computer PC to a network enabled Personal Digital Assistant PDA to a mobile phone. The interactive image surfing application co-ordinates the data layer/application layer session and control layer/session control layer. Any such device or terminal may act as a client or even as a server. This is dependent on whether it requests content to be exchanged (then acting as a client entity) or whether it has content stored or has access to content which is requested to be delivered to another terminal/client (then acting as a server entity).

The content such as images could either be stored locally on the terminal device or in a centrally located server. This depends on the level of “autonomy” desired of the JPIP server offering image browsing. With the advances in image capturing techniques, high-end image phones are already a reality. Captured images could either be stored in file-system on the mobile phone or on a dedicated server. These images could be associated with metadata. This metadata can be used to be stored as access control criteria and also as access-control information for rendering the image list to a client request. Note that criteria is a functionality related term (such as e.g. “soccer” images or “birthday” images), and such access-control information, i.e. criteria, grant access rights to user groups having subscribed to content matching such criterion. Since usage of the SIP INFO message based method is already part of the SIP framework, only the image surfing application needs to incorporate the changes. The application sends the INFO image-listing request to the server along with some content access criteria, the server then responds with the content (image) list based not only on the client provided criteria but also based on the client-user content access control policy. It is noted again that the access-control policy is not the SIP session establishment policy, but related to content-access level of the client. I.e., a client could establish a SIP call but not be allowed to view a particular image or view it with restriction. The server ignores client-request content access criteria if it cannot interpret it. The user access control check performed at the server side could also be optional.

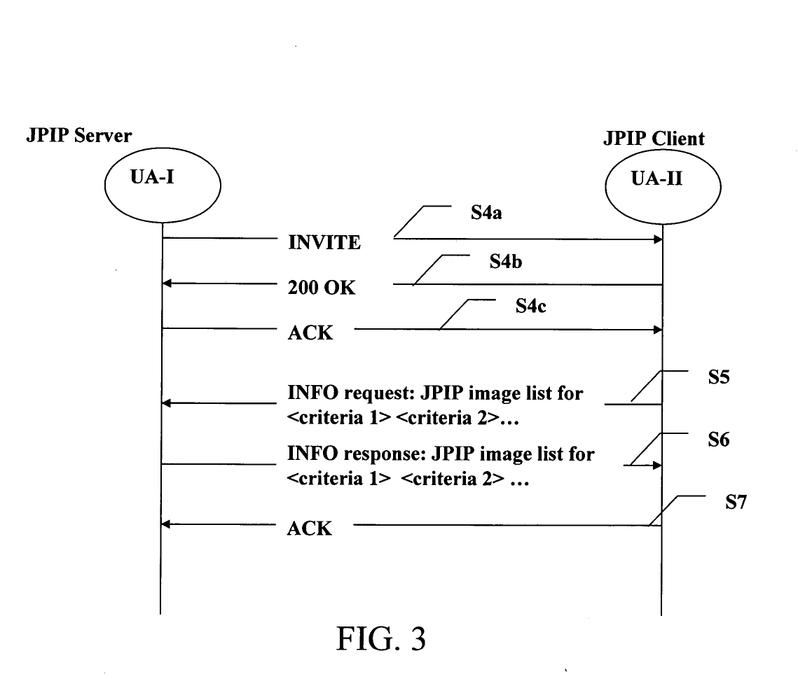

The mid-session data transfer could include the following steps (referring to FIG. 3):
1—Establish JPIP session using SIP and SDP based Offer-Answer model.
2—Request image-listing using SIP INFO message based method with some content access criteria.
3—Choose a target from the list.
4—JPIP based image-browsing session for the chosen target/image name.
5—Repeat steps 3, 4 for a different target/image name with same content access criteria or repeat 1-4 for a new content access criterion.

The most positive aspect of utilizing such method based on the SIP INFO message to transport mid-session application data is that it can utilize existing SIP and JPIP stacks if they are already available on the multimedia terminal. The modifications in the interactive image browsing system involve changes only in the controlling application, i.e. it would have to send SIP INFO requests after SIP session establishment and be able to generate the response based on the INFO request.

JPIP will be used in applications that require transfer of image data between two users, usually a client and a server. The applications where JPIP can be used include e.g. interactive image browsing, image databases and image sharing (when referring to images as an example of content). If SIP is used as the signaling protocol, the presence of SIP INFO messages can be seen examining the transferred messages at either end. If SIP INFO messages are detected, it is relatively simple to determine whether they are used to transfer intra-session control data, e.g. if they contain information related to targets residing on the device, e.g. image names, filenames, metadata such as creation times and so on.

FIGS. 3 to 5 show examples of the present invention being applied to different concepts (scenarios) In the Figures, a server entity and client entity as well as the signaling between these is illustrated. Signaling not related to understanding of the present invention is omitted to keep the explanations simple. The vertical sequence of messages represents the time sequence of messages exchanged. In the chosen examples, the client and servers are assumed to be JPIP enabled servers running a JPIP application layer session on top of a SIP/SDP stack as a control layer session.

FIG. 3 shows a content access control case where image listing is offered on the basis of some server specified content access control criteria.

Using commonly known SIP messages such as “INVITE” and “200 OK”, and “ACK” the client-server pair establishes a SIP based control layer session, as shown in Steps S4a, S4b, S4c.

Thereafter, there is a step S5 of requesting (INFO request), by the client entity, for an indication of content accessible for the content exchange session. This step uses SIP INFO message and requests for a list of JPIP images as content. In the requesting step, there can be implemented a pre-selecting according to at least one content access criterion such as criterion1, criterion 2, . . . for the content to be accessed in the content exchange session. A criterion can be related to metadata available for content such as a content description, content date (creation or modification), content size or content source or any other suitable attribute by means of which content may be identified and/or selected to be accessed.

The transmitting step further comprises a step S6 of responding (INFO response), by the server entity, to the request for an indication, wherein the responding step further comprises a step of indicating accessible content, if the request was judged by the server entity to be granted. This means that for the content access criteria specified in the preceding request, the response indicates a list of content files such as image files or images, which satisfy those criteria.

Therefore, it is implied that said responding step comprises a step of judging, prior to indicating, whether the request received matches at least one content access criterion for requests of the client entity, wherein the request is granted, if it is judged that a matching content access criterion is present. The step of judging is based on at least a client entity's content access profile. A client entity's content access profile being defined for e.g. the client entity's identity and its subscription attributed to a service such as access rights to specific content (e.g. sports, but no “adult-content”, personal—to be shared only with a trusted-list, etc), charging details (bandwidth usage), QoS (e.g. bitrate, belongs to what class of QoS—“Interactive”, “Background”, etc), etc., which define the content access profile.

Notwithstanding this, the step of judging is based on at least one further content access criterion for the content to be accessed in the content exchange session and contained in the request step. Namely, such further criterion is specified by the metadata indicated in the request and used to retrieve/select specific content (e.g. date of content creation, size of content, etc).

The response received at the client entity from the server entity, Step S6, is acknowledged, Step S7, using a SIP ACK message, as shown in FIG. 3.

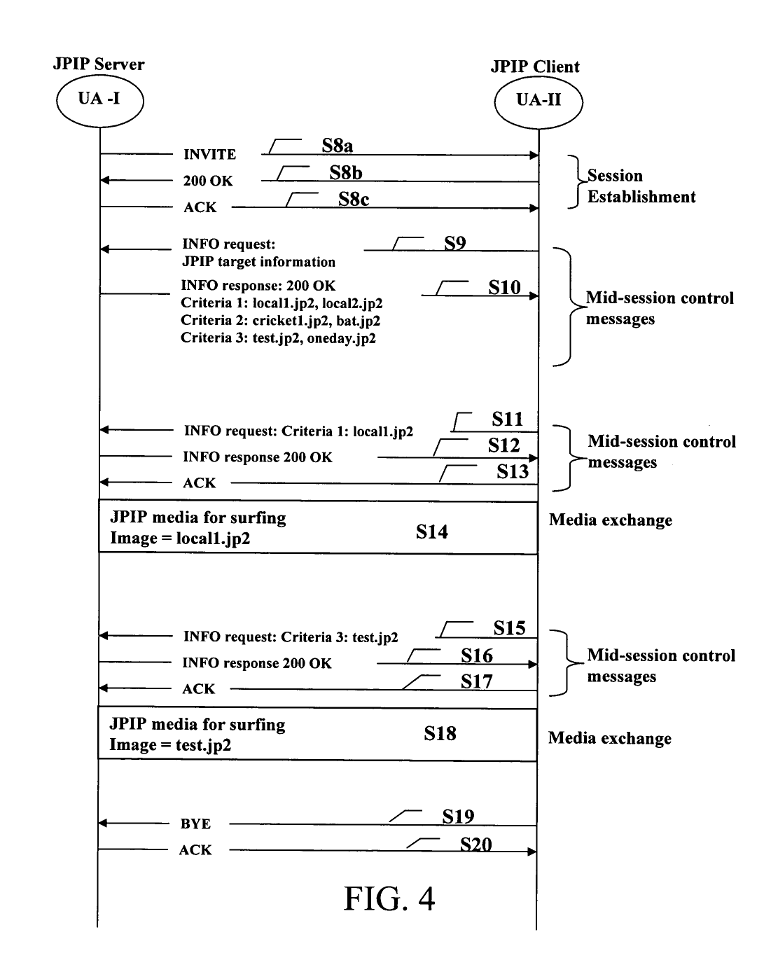

FIG. 4 shows a typical “target-change” case of a target-change by the client based on information supplied by the server. In this scenario, again after session establishment comprising a INVITE, 200 OK and ACK message, (steps S8a, S8b, S8c) the client entity requests for target information, i.e. accessible content using a SIP INFO request message for JPIP target information, step S9. The request is answered using a SIP INFO response: 200 OK (step S10) message which indicates for various content access criteria such as criteria 1, criteria 2, criteria 3 the respective content matching these content access criteria and accessible by the client in the JPIP session. Receipt of this information is (optionally) again acknowledged (not shown in the signaling diagram of FIG. 4). The answer of the server in step S10 depends on e.g. the client's profile and/or at least one further content access criterion for the content to be delivered in the content exchange session and contained in the request step of Step S9.

(Note that no indication could be returned to the client if the client is not authorized to access content from the server, as set out in connection with the preceding scenario of FIG. 3 which can be combined with the present one.)

After those initial mid-session control messages of steps S9, S10, the client (i.e. the user) selects from the available (accessible) content a content desired to be accessed and issues a SIP INFO request (step S11) specifying a selected content access criterion and a selected content file, e.g. file “locall.jp2” under “criterion 1”. The server, in step S12, responds to the request using a INFO response: 200 OK message to thereby acknowledge receipt of the request, which 200 OK message is in turn acknowledged by the client using a SIP ACK message (step S13).

Afterwards, media exchange is initiated and the JPIP media stream for surfing the content, e.g. image identified by “locall.jp2” is exchanged between server and client in a JPIP session represented by step S14. (Note that the JPIP session may comprise several individual steps, which are summarized as step S14 in order to keep the explanations simple.)

Using similar requests, the content exchanged in a JPIP session may afterwards be changed to the content identified by “test.jp2”, as shown in the example given in FIG. 4. More precisely, using mid-session control messages in steps S15, S16, and S17, the content exchanged in a subsequent JPIP based media exchange session (S18) is changed to a content (image) file named “test.jp2” in this example.

Finally, the session is terminated (client based) using a BYE message (step S19), which is also acknowledged in a step S20. Termination of the session may, however, be server based (not shown in the Figure). A server based session termination may depend on the client's content access profile or the like.

Note that ACK messages are optional. Also, termination of a session could be server initiated. The number of criteria specified in a SIP INFO message is not limited to the numbers shown in the illustrated example. Also, the number of content file names is not limited to the shown examples. Metadata and/or (content access) selection criteria are variable in a wide range and not restricted to those examples outlined above. Various other types/categories of metadata are possible.

From the preceding description it thus becomes clear that the present invention concerns in regard of the transmitting step, a further step of requesting, by the client entity, for delivering a specified content accessible for the content exchange session. The transmitting step further comprises a step of responding, by the server entity, to the request for delivering, wherein the responding step further comprises a step of delivering the requested content in the content exchange session. The transmitting step further comprises a step of responding, by the server entity, to the request for delivering, wherein the responding step further comprises a step of delivering the requested content if the request was judged by the server entity to be granted. The responding step comprises a step of judging, prior to delivering, whether the request received matches at least one content access criterion for requests of the client entity, wherein the request is granted if it is judged that a matching content access criterion is present. The step of judging is based on at least a client entity's content access profile. And, the step of judging is based on at least one further content access criterion for the content to be delivered in the content exchange session and contained in the request step.

FIG. 5 shows the case of “real-time update”, which is enabled according to another aspect of the present invention, which would not be possible if the target information is sent only during the startup (of the control layer session).

In this regard, the first six method steps of the signaling shown in FIG. 5, i.e. steps S21a, S21b, S21c, S22, S23 and S24 are similar to those described in relation to FIG. 3 (steps S4a to S7). Similarly, the last three messages shown in FIG. 5 (steps S28, S29, and S30) are similar to those last three messages S5, S6, and S7 already described with reference to FIG. 3. A repeated description thereof is therefore omitted here.

New steps involved in this scenario are as follows:

There is a step S31 of detecting, at the server entity, the occurrence of additional content. Additional content may also mean updated content i.e. a new version of a previous content. Namely, at the server entity it is (continuously or in regular intervals) monitored during step S31 whether new content such as a new image “image 6” is captured (using image pickup means at the server's location) or otherwise made available on the server (e.g. loaded from a remote location to the server). Availability on the server may for example originate from the content being received from a further remote entity or from the content being generated (by taking a picture at the server entity) and storing it at the server entity or at a remote location accessible by the server entity. Other reasons for availability of such new/additional content on the server are possible.

If detected, there occurs a step, S25, of indicating, by the server entity to the client entity, an indication of content accessible for the content exchange session, wherein the indication comprises at least an information related to the additional content. Stated in other words, the server entity issues a SIP INFO request to the client entity and informs the client entity of an updated content accessible by the client at or via the server (S25: INFO request: JPIP image list update). The client acknowledges this update with a corresponding message, INFO response: update received, in step S26, which is in turn acknowledged by the server using SIP ACK in Step S27.

Afterwards, the newly available content is accessible to the client with the same SIP session/JPIP session and can be accessed/selected according to one of the preceding described scenarios.

Although the present invention has been described herein above mainly with regard to the method and signaling involved, it is apparent that the present invention also concerns correspondingly adapted client and server entities, which in cooperation constitute an accordingly configured system.

It is to be noted that the client/server entities are illustrated and described with reference to block circuit diagrams only to keep the description comprehensive. Among the blocks of the block circuit diagrams, only those interconnections having a relation to the claimed invention are illustrated. However, this does not exclude other interrelations/interconnections between blocks from existing. However, those interconnections not shown may be considered to be inherent to such arrangement as will be appreciated by those skilled in the art. Although blocks are sometimes illustrated as distinct blocks, the actual realization could be in a single block, since the block circuit diagram is conceived to illustrate and explain the functional interrelations between blocks of a client/server entity and between a client entity and a server entity. Moreover, the block circuit diagrams represent the devices in terms of the layered protocol stacks underlying their operational behavior. Hence, distinct blocks could be jointly realized using e.g. only one DSP device or ASIC. It is emphasized again that a terminal and/or a user agent UA of such terminal may combine a server entity functionality as well as a client entity functionality. However, in order to keep the drawing and explanation simple, such aspects are described and illustrated separately.

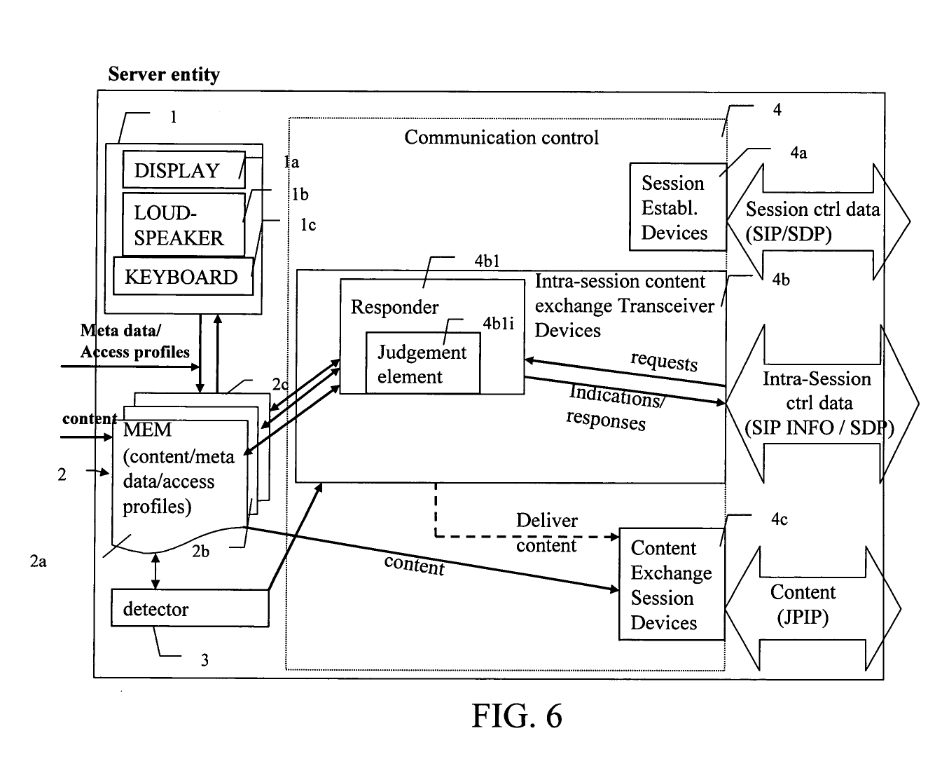

FIG. 6 shows as a block circuit diagram those components of a server entity being related to a server entity aspect the present invention.

The server entity comprises a man-machine-interface MMI (numeral 1), comprising for example a display 1a, a loudspeaker 1b, and a keyboard 1c. However, additional or alternative input and/or output devices can be provided (such as e.g. a (video/still picture) camera, a mouse, a pen, etc.), including the omission of one of those shown.

The MMI 1 is connectable and/or connected to a memory means MEM 2. The memory MEM 2 can be a single memory means having individual partitions or can be configured to consist of individual memory elements. Partitions or elements of the memory are denoted with numerals 2a, 2b, 2c, respectively, and store therein content data, metadata, and client's content access profiles.

Content data are supplied from e.g. an external device (not shown) such as a camera, which may also form part of the MMI 1 as explained above, or from an external data source such as a server. This is indicated by the arrow labeled “content”. Metadata as well as client's content access profiles can likewise be supplied from the external device, as indicated by the correspondingly labeled arrow from the left, or can be input from the MMI 1 as indicated by the vertical (downward) arrow. Any data in the memory partitions/elements can be output to the MMI 1, as illustrated by the vertical upward arrow. Outputting to the MMI 1 may serve for displaying or playing (using loudspeaker) the data or even for editing data usig the keyboard.

Connected to the memory partition 2a maintaining and/or receiving content data is a detector 3. The detector detects the occurrence of new and/or additional or updated content.

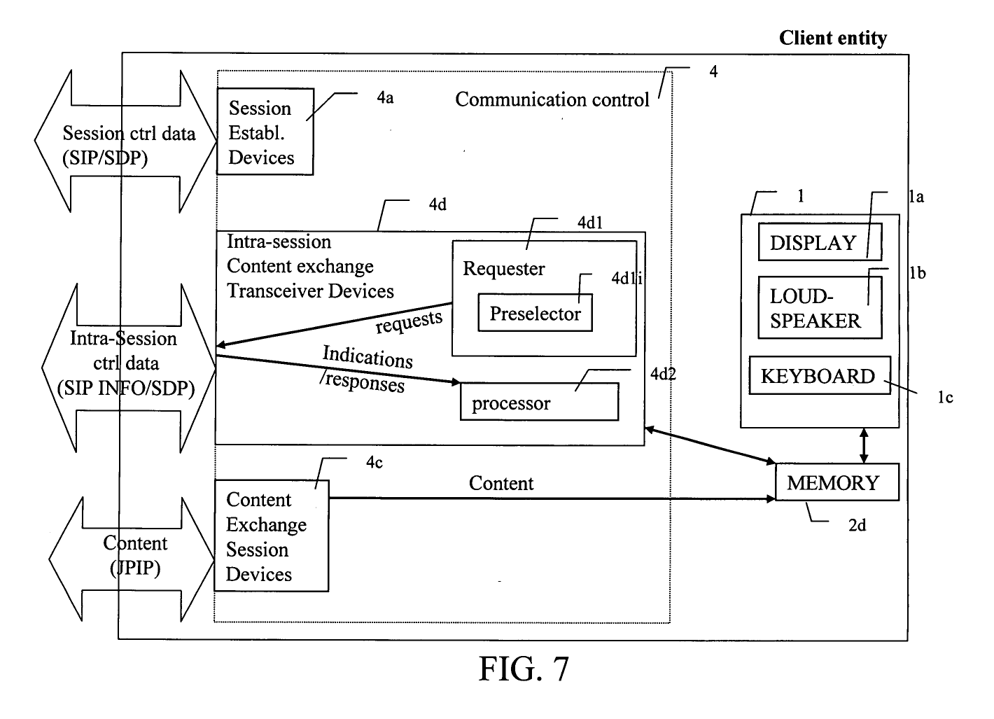

The memory MEM 2 and detector 3 are connected to communication control 4 of the server entity. The communication control 4 comprises session establishment devices 4a, content exchange session devices 4c and intra-session content exchange transceiver devices 4b. These devices constitute respective interfaces towards a client entity to be described with reference to FIG. 7 below.

The session establishment devices 4a are configured for bidirectional exchange of session initiation and control data with the client entity. The content exchange session devices 4c are configured for bidirectional exchange of content data with the client entity. The intra-session content exchange transceiver devices 4b are configured for bidirectional exchange of intra-session control data with the client entity. (Note that intra-session content exchange mainly refers to an communication of intra-session control data and should not be mixed up with “content” as such exchanged in content exchange sessions such as JPIP sessions.)

Among intra-session control data, requests are received from the client entity at the server entity's transceiver devices 4b and internally forwarded to a responder 4b1. The responder 4b1 comprises a judgment element 4b1i. The judgment element 4b1i judges whether the received request can be granted based on the request and the information in the memory partitions 2b, 2c in particular. In case a request can be granted, corresponding information is issued to the client entity in an indication response.

Furthermore, the responder 4b1 is responsive to an input from the detector 3 and issues a indication/response to the client entity if new (additional) or updated content is detected.

In view of the fact that the session establishment devices 4a operate based on a session control layer protocol (e.g. SIP/SDP) and the transceiver devices 4b rely on an intra-session transport mechanism based on using a SIP INFO message (e.g. SIP INFO/SDP), and the content exchange session devices operate based on an application layer protocol, there occurs an inter-protocol layer interaction. This implies that though not shown there is a certain control information flow between the protocol layers and the devices representing them, which in consequence is responsible for the content to be exchanged.

Stated in other words, a server entity in accordance with the present invention is configured to exchange content with a client entity. The server entity comprises session establishment devices, configured to establish a session between the server entity and the client entity based on a session control layer protocol, content exchange session devices, configured to exchange content within a session between the server entity and the client entity based on an application layer session protocol, and intra-session content exchange transceiver devices, configured to transmit intra-session control data based on an intra-session transport mechanism of the session control layer protocol, wherein said intra-session control data is configured to control the content exchange session.

The server entity further comprises at least one memory configured to store content, wherein content consists of at least one of audio data, video data, image data, text data, and metadata descriptive of attributes of the audio, video, image and/or text data.

As mentioned above, the session control layer protocol is the Session Initiation Protocol, SIP, and the session established is a SIP session; the application layer session protocol is the JPEG 2000 Interactive Protocol, JPIP, and the content exchange session established is a JPIP session, and further the intra-session transport mechanism of the session control layer protocol carries the intra-session control data along the signaling path of the session control layer protocol (or, as they do not have to go through the signaling path, they can be exchanged end-to-end). More precisely, as an example, the session control layer protocol is the Session Initiation Protocol, SIP, and the session established is a SIP session, and the intra-session transport mechanism is the SIP INFO method of the session control layer protocol.

In connection with the server entity, the transceiver further comprises a responder configured to respond to a request for an indication received from a client entity, wherein the responder is configured to indicate, in the response, content accessible if the request was judged to be granted.

The responder comprises a judgment element, configured to judge whether the request received matches at least one content access criterion for requests of the client entity, wherein the request is granted if it is judged that a matching content access criterion is present. The judgment element is configured to make a judgment based on at least a client entity's content access profile. The judgment element is configured to make a judgment based on at least one further content access criterion for the content to be accessed in the content exchange session and contained in the request step.

In connection with the server entity, the transceiver further comprises a responder configured to respond to a request for delivering from a client entity, wherein

the responder is further configured to deliver the requested content in the content exchange session.

Delivering content is intended to be understood also as triggering the delivering of the content. In FIG. 6, such triggering is indicated by a trigger signal “deliver content” (indicated as a dotted line) issued from device 4b (i.e. 4b1 or even 4b1i) to the device 4c. Content as such is delivered from the memory 2 to the device 4c, indicated as a bold solid line.

The transceiver further comprises a responder, configured to respond to the request for delivering, wherein the responder is further configured to deliver the requested content if the request was judged by the server entity to be granted. The responder comprises a judgment element, configured to judge, prior to delivering, whether the request received matches at least one content access criterion for requests of the client entity, wherein the request is granted if it is judged that a matching content access criterion is present. The judgment is based on at least a client entity's content access profile.

Nevertheless, the judgment is optionally based on at least one further content access criterion for the content to be delivered in the content exchange session and contained in the request.

In relation to a real-time update, the server entity further comprises a detector configured to detect the occurrence of additional content. The transceiver is configured to indicate, responsive to the detector, to the client entity, content accessible for the content exchange session, wherein the indication comprises at least an information related to the additional content.

FIG. 7 shows as a block circuit diagram those components of a client entity being related to a client entity aspect the present invention.

Similarly to the server entity, the client entity comprises a man-machine-interface MMI (numeral 1), comprising for example a display 1a, a loudspeaker 1b, and a keyboard 1c. However, additional (such as a (video/still image) camera) or alternative input and/or output devices can be provided (e.g. a mouse, pen, etc.), including the omission of one of those shown. The MMI 1 is connectable and/or connected to a memory means MEM 2d. The memory MEM 2d can be a single memory means having individual partitions or can be configured to consist of individual memory elements. Under a client entity aspect, the memory means mainly serves as a working memory, e.g. for intermediate storage of content for display purposes, or the like. In case of an entity with combined client server functionalities, the client memory 2 is for example a further separate partition 2d of the server memory 2a, 2b, 2c. Using the MMI 1, content delivered to the client entity can be output for perception by the client entity's user.

Using e.g. the keyboard, a user may input and/or create or modify his user (client) entity's content access profile. Inputting here means also selecting a predefined profile from a plurality of such (pre-existing) profiles. Any such input is optionally at least buffered in the memory 2d. Information in the memory are accessible by the intra-session content exchange transceiver devices 4d, and the transceiver devices may write information such as responses/indications from a server entity to the memory means 2d for being brought to the user's attention via the MMI 1. Content as such exchanged in the content exchange session is supplied to the memory 2d from the content exchange session devices 4c. These relations are indicated by the arrows in FIG. 7.

The memory MEM 2d (and at least via the memory 2d also the MMI 1) are connected to communication control 4 of the client entity. The communication control comprises session establishment devices 4a, content exchange session devices 4c and intra-session content exchange transceiver devices 4d. These devices constitute respective interfaces towards a server entity described with reference to FIG. 6 above.

The session establishment devices 4a are configured for bidirectional exchange of session control data with the client entity. The content exchange session devices 4c are configured for bidirectional exchange of content data with the client entity. The intra-session content exchange transceiver devices 4d are configured for bidirectional exchange of intra-session control data with the client entity.

Among intra-session control data, requests are issued from the client entity to the server entity's intra-session content exchange transceiver devices 4b, i.e. internally generated at a requester 4d1. The requester 4d1 comprises a pre-selector element 4d1i. Indications/responses are received at the client entity from the server entity and internally processed using a processor 4d2.

Thus, stated in other words, the client entity is configured to exchange content with a server entity, and

comprises session establishment devices configured to establish a session between a server entity and the client entity based on a session control layer protocol, content exchange session devices configured to exchange content within a session between the server entity and the client entity based on an application layer session protocol, and transceiver devices configured to transmit intra-session control data based on an intra-session transport mechanism of the session control layer protocol, wherein said intra-session control data is configured to control the content exchange session.

Content exchanged consists of at least one of audio data, video data, image data, text data, and metadata descriptive of attributes of the audio, video, image, and/or text data. The session control layer protocol is the Session Initiation Protocol, SIP, and the session established is a SIP session; the application layer session protocol is the JPEG 2000 Interactive Protocol, JPIP, and

the content exchange session established is a JPIP session; the intra-session transport mechanism of the session control layer protocol carries the intra-session control data along the signaling path of the session control layer protocol or, as they do not have to go through the signaling path, they can be exchanged end-to-end; the session control layer protocol is the Session Initiation Protocol, SIP, and the session established is a SIP session, and the intra-session transport mechanism is the SIP INFO method of the session control layer protocol.

Under an aspect of access control, the client entity, more particularly, the intra-session content exchange transceiver device, further comprises a requester configured to request, from the server entity, for an indication of content accessible for the content exchange session. The requester further comprises a pre-selector configured to pre-select at least one content access criterion for the content to be accessed in the content exchange session. This can be based on a keyboard input, for example.

Under the aspect of a target change, the client entity, in particular the intra-session content exchange transceiver further comprises a requester configured to request, from the server entity, for delivering a specified content accessible for the content exchange session. This can be based on a keyboard input, for example.

Thus, the present invention has been described in detail above under a method aspect as well as client entity and server entity aspect. It is well understood that a corresponding system comprising a server entity and a client entity in interaction with each other according to the present invention can be established and is covered by the idea underlying the present invention.

As has been described herein above, the present invention discloses a method for exchanging content between a server entity and a client entity. The method comprises the steps of establishing a session between the server entity and the client entity based on a session control layer protocol, initiating a content exchange session between the server entity and the client entity based on an application layer session protocol. Furthermore, the method includes transmitting intra-session control data based on a transport mechanism of the session control layer protocol, wherein said intra-session control data controls the content exchange session.

1. A method for exchanging content between a server entity and a client entity,
the method comprising the steps of:
establishing a session between the server entity and the client entity based on a session control layer protocol;
initiating a content exchange session between the server entity and the client entity based on an application layer session protocol; and
transmitting intra-session control data based on an intra-session transport mechanism of the session control layer protocol, wherein said intra-session control data controls the content exchange session.

2. A method according to claim 1, wherein the content consists of at least one of audio data, video data, image data, text data, and metadata descriptive of attributes of the at least one audio data, video data, image data, and text data.

3. A method according to claim 1, wherein the session control layer protocol is a Session Initiation Protocol (SIP), and the session established is a SIP session.

4. A method according to claim 1, wherein the application layer session protocol is the JPEG 2000 Interactive Protocol (JPIP), and the content exchange session established is a JPIP session.

5. A method according to claim 1, wherein
the session control layer protocol is the Session Initiation Protocol (SIP), and the session established is a SIP session, and
the intra-session transport mechanism is based on a SIP INFO message.

6. A method according to claim 1, wherein the transmitting step further comprises a step of;
requesting, by the client entity, for an indication of content accessible for the content exchange session.

7. A method according to claim 6, wherein the requesting step further comprises a step of;
pre-selecting at least one criterion for the accessible content to be accessed in the content exchange session.

8. A method according to claim 6, wherein the transmitting step further comprises a step of
responding, by the server entity, to the request for an indication, wherein
the responding step further comprises a step of
indicating content accessible if the request for an indication was judged by the server entity to be granted.

9. A method according to claim 8, wherein said responding step comprises a step of:
judging, prior to indicating, whether the request for an indication received, matches at least one content access criterion for requests of the client entity, wherein the request for an indication is granted if it is judged that a matching content access criterion is present.

10. A method according to claim 9, wherein the step of judging is based on at least a client entity's content access profile.

11. A method according to claim 10, wherein the step of judging is based on at least one further content access criterion for the content to be accessed in the content exchange session and contained in the request step.

12. A method according to claim 1, wherein the transmitting step further comprises a step of:
requesting, by the client entity, delivery of a specified content accessible for the content exchange session.

13. A method according to claim 1, wherein the transmitting step further comprises a step of:
responding, by the server entity, to the request for delivery, wherein
the responding step further comprises a step of
delivering the requested content in the content exchange session.

14. A method according to claim 13, wherein the transmitting step further comprises a step of:
responding, by the server entity, to the request for delivery, wherein
the responding step further comprises a step of
delivering the requested content if the request was judged by the server entity to be granted.

15. A method according to claim 14, wherein said responding step comprises a step of judging, prior to delivery, whether the request received matches at least one content access criterion for requests of the client entity, wherein the request is granted if it is judged that a matching content access criterion is present.

16. A method according to claim 15, wherein the step of judging is based on at least a client entity's content access profile.

17. A method according to claim 16, wherein the step of judging is based on at least one further content access criterion for the content to be delivered in the content exchange session and contained in the request step.

18. A method according to claim 1, further comprising a step of:
detecting, at the server entity, an occurrence of additional content.

19. A method according to claim 18, further comprising a step of:
indicating, by the server entity to the client entity, an indication of content accessible for the content exchange session, wherein the indication comprises at least an information related to the additional content.

20. A system configured to exchange content between a server entity and a client entity,
the system comprising:
session establisher devices at the server entity and the client entity, configured to establish a session between the server entity and the client entity based on a session control layer protocol;
content exchange session initiator devices, at the server entity and the client entity, configured to initiate a content exchange session between the server entity and the client entity based on an application layer session protocol; and
transceiver devices, at the server entity and the client entity, configured to transmit and receive intra-session control data based on an intra-session transport mechanism of the session control layer protocol, wherein said intra-session control data is configured to control the content exchange session.

21. A system according to claim 20, further comprising at least one memory configured to store content, wherein the content consists of at least one of audio data, video data, image data, text data, and metadata descriptive of attributes of the at least one audio data, video data, image data, and text data.

22. A system according to claim 20, wherein the session control layer protocol is the Session Initiation Protocol (SIP), and the session established is a SIP session.

23. A system according to claim 20, wherein the application layer session protocol is the JPEG 2000 Interactive Protocol (JPIP), and the content exchange session established is a JPIP session.

24. A system according to claim 20, wherein the session control layer protocol is the Session Initiation Protocol (SIP), and the session established is a SIP session; and
the intra-session transport mechanism is based on the SIP INFO message.

25. A system according to claim 20, wherein the transceiver device further comprises:
a requester, at the client entity, configured to request for an indication of content accessible for the content exchange session.

26. A system according to claim 25, wherein the requester further comprises:
a pre-selector configured to pre-select at least one content access criterion for the content to be accessed in the content exchange session.

27. A system according to claim 25, wherein the transceiver further comprises:
a responder, at the server entity, configured to respond to the request for an indication, wherein the responder is configured to indicate, in the response to the request for indication, content accessible if the request was judged by the server entity to be granted.

28. A system according to claim 27, wherein said responder comprises:
a judgment element, configured to judge, prior to a response with an indication, whether the request received matches at least one content access criterion for requests of the client entity, wherein the request is granted if it is judged that a matching content access criterion is present.

29. A system according to claim 28, wherein the judgment element is configured to make a judgment based on at least a client entity's content access profile.

30. A system according to claim 29, wherein the judgment element is configured to make a judgment based on at least one further content access criterion for the content to be accessed in the content exchange session and contained in the request step.

31. A system according to claim 20, wherein the transceiver further comprises:
a requester, at the client entity, configured to request for delivering a specified content accessible for the content exchange session.

32. A system according to claim 20, wherein the transceiver further comprises
a responder, at the server entity, configured to respond to a request for delivery, wherein the responder is further configured to deliver the requested content in the content exchange session.

33. A system according to claim 32, wherein the transmitting further comprises:
a responder, at the server entity, configured to respond to the request for delivery, wherein the responder is further configured to deliver the requested content if the request was judged by the server entity to be granted.

34. A system according to claim 33, wherein said responder comprises:
a judgment element, configured to judge, prior to delivery, whether the request received matches at least one content access criterion for requests of the client entity, wherein the request is granted if it is judged that a matching criterion is present.

35. A system according to claim 34, wherein the judgment is based on at least a client entity's content access profile.

36. A system according to claim 35, wherein the judgment is based on at least one further content access criterion for the content to be delivered in the content exchange session and contained in the request step.

37. A system according to claim 20, further comprising a detector, at the server entity, configured to detect an occurrence of additional content.

38. A system according to claim 37, wherein the transceiver, at the server entity, is configured to indicate, responsive to the detector and from the server entity to the client entity, content accessible for the content exchange session, wherein the indication comprises at least an information related to the additional content.

39. A server entity configured to exchange content with a client entity, the server entity comprising:
session establisher devices, configured to establish a session between the server entity and the client entity based on a session control layer protocol;
content exchange session initiator devices, configured to initiate a content exchange session between the server entity and the client entity based on an application layer session protocol; and
transceiver devices, configured to transmit intra-session control data based on an intra-session transport mechanism of the session control layer protocol, wherein said intra-session control data is configured to control the content exchange session.

40. A server entity according to claim 39, further comprising
at least one memory configured to store content, wherein content consists of at least one of audio data, video data, image data, text data, and metadata descriptive of attributes of the at least one audio data, video data, image data and text data.

41. A server entity according to claim 39, wherein the session control layer protocol is the Session Initiation Protocol (SIP), and the session established is a SIP session.

42. A server entity according to claim 39, wherein the application layer session protocol is the JPEG 2000 Interactive Protocol (JPIP), and the content exchange session established is a JPIP session.

43. A server entity according to claim 39, wherein the session control layer protocol is the Session Initiation Protocol (SIP), and the session established is a SIP session; and
the intra-session transport mechanism is based on the SIP INFO message.

44. A server entity according to claim 39, wherein the transceiver further comprises:
a responder configured to respond to a request for an indication received from a client entity, wherein the responder is configured to indicate in response, content accessible if the request was judged to be granted.

45. A server entity according to claim 44, wherein said responder comprises:
a judgment element, configured to judge whether the request received matches at least one content access criterion for requests of the client entity, wherein the request is granted if it is judged that a matching content access criterion is present.

46. A server entity according to claim 45, wherein the judgment element is configured to make a judgment based on at least a client entity's content access profile.

47. A server entity according to claim 46, wherein the judgment element is configured to make a judgment based on at least one further content access criterion for the content to be accessed in the content exchange session and contained in the request step.

48. A server entity according to claim 39, wherein the transceiver further comprises:
a responder configured to respond to a request for delivery from a client entity, wherein
the responder is further configured to deliver the requested content in the content exchange session.

49. A server entity according to claim 48, wherein the transceiver further comprises
a responder, configured to respond to the request for delivey, wherein
the responder is further configured to deliver the requested content if the request was judged by the server entity to be granted.

50. A server entity according to claim 49, wherein said responder comprises:
a judgment element, configured to judge, prior to delivery, whether the request received matches at least one content access criterion for requests of the client entity, wherein the request is granted if it is judged that a matching content access criterion is present.

51. A server entity according to claim 50, wherein the judgment is based on at least a client entity's content access profile.

52. A server entity according to claim 51, wherein the judgment is based on at least one further content access criterion for the content to be delivered in the content exchange session and contained in the request.

53. A server entity according to claim 39, further comprising
a detector configured to detect the occurrence of additional content.

54. A server entity according to claim 53, wherein the transceiver is configured to indicate, responsive to the detector, to the client entity, content accessible for the content exchange session, wherein the indication comprises at least an information related to the additional content.

55. A client entity configured to exchange content with a server entity,
the client entity comprising:
session establisher devices configured to establish a session between a server entity and the client entity based on a session control layer protocol;
content exchange session initiator devices configured to initiate a content exchange session between the server entity and the client entity based on an application layer session protocol; and
transceiver devices configured to transmit intra-session control data based on an intra-session transport mechanism of the session control layer protocol, wherein said intra-session control data is configured to control the content exchange session.

56. A client entity according to claim 55, wherein content exchanged consists of at least one of audio data, video data, image data, text data, and metadata descriptive of attributes of the at least one of audio data, video data, image data, and text data.

57. A client entity according to claim 55, wherein the session control layer protocol is the Session Initiation Protocol (SIP), and the session established is a SIP session.

58. A client entity according to claim 55, wherein the application layer session protocol is the JPEG 2000 Interactive Protocol (JPIP), and the content exchange session established is a JPIP session.

59. A client entity according to claim 55, wherein the session control layer protocol is the Session Initiation Protocol (SIP), and the session established is a SIP session; and
the intra-session transport mechanism is based on the SIP INFO message.

60. A client entity according to claim 55, wherein the transceiver device further comprises:
a requester configured to request, from the server entity, an indication of content accessible for the content exchange session.

61. A client entity according to claim 60, wherein the requester further comprises:
a pre-selector configured to pre-select at least one content access criterion for the content to be accessed in the content exchange session.

62. A client entity according to claim 55, wherein the transceiver further comprises
a requester configured to request, from the server entity, for delivery of a specified content accessible for the content exchange session.
